(19) United States
(12) Patent Application Publication
(10) Pub. No.: US 2011/0104047 A1
(43) Pub. Date: May 5, 2011

(54) MODIFIED COBALT OXIDE BASED CATALYST FOR PRODUCING HYDROGEN, ITS PREPARATION METHOD AND USES THEREOF

(75) Inventors: Chuin-Tih YEH, Hsinchu City (TW); Chen-Bin WANG, Taipei City (TW); Chia-Chan LEE, Taipei County (TW)

(73) Assignee: NATIONAL DEFENSE UNIVERSITY, Taoyuan County (TW)

(21) Appl. No.: 12/693,447

(22) Filed: Jan. 26, 2010

(30) Foreign Application Priority Data
Oct. 30, 2009 (TW) 98136934

(51) Int. Cl. C01B 3/08; B01J 23/83; B01J 23/75

(52) U.S. Cl. 423/657; 502/303

(57) ABSTRACT

Provided herein is a modified cobalt oxide based catalyst that includes cobalt oxide and lanthanum. The lanthanum is dispersed within the cobalt oxide, wherein the lanthanum is about 5-20% by weight of the modified cobalt oxide based catalyst. The method of producing the lanthanum modified cobalt oxide based catalyst and its use in producing hydrogen are also disclosed.

### RELATED APPLICATIONS

This application claims priority to Taiwan Application Serial Number 98136934, filed Oct. 30, 2009, which is herein incorporated by reference.

### BACKGROUND

1. Field of Invention

The present disclosure in general relates to a cobalt oxide based catalyst. More particularly, it relates to a modified cobalt oxide based catalyst that may effectively reduce the amount of carbon that is produced and accumulated on the catalyst in an ethanol-hydrogen conversion process.

2. Description of Related Art

Hydrogen is often used in a fuel cell to generate electricity through reacting with oxygen. Using hydrogen as a fuel may effectively reduce the emission of green house gases due to the reason that hydrogen has much higher energy conversion efficiency. Currently, hydrogen is mainly produced from fossil oils, and is stored and distributed in gas cylinders or gas tanks and thereby renders the transportation cost at a relatively high level. The transportation cost may be lowered if hydrogen could be produced on site from an organic material having high energy density through a simple chemical reaction.

Steam reforming of ethanol (SRE) is a catalytic process for generating hydrogen from an alcohol solution at high temperature. In the known method, an oxide such as MgO, Al₂O₃, SiO₂, TiO₂ or ZnO, having absorbed therein a cobalt containing compound, such as Co carbonyl (CO₂(CO)₈), is often used in the catalytic process to generate hydrogen. Although the hydrogen conversion efficiency of such method may be satisfactory, yet the cost of the raw material (i.e., CO₂(CO)₈) is too expensive to render such method any practical commercial value. An improved method is therefore suggested, which uses cobalt nitrate (Co(NO₃)₂) as a starting material for the preparation of a cobalt oxide catalyst of a hydrogen producing process. The cobalt oxide catalyst thus produced has good activity, however, coke produced and accumulated during the SRE catalytic reaction would inevitably shorten the life time of the cobalt oxide catalyst.

In view of the above, there exist in this art a need of an improved cobalt oxide catalyst, which has a relatively longer life time and may steadily catalyze the conversion of ethanol into hydrogen.

### SUMMARY

In view of the above, the objective of this disclosure aims to provide an improved catalyst, which has an improve activity, life time and stability over a known cobalt oxide based catalyst, and may further reduce the coke formed in the conversion process (i.e., ethanol is converted into hydrogen) from being accumulated on the catalyst.

In the first aspect, the disclosure provides a modified cobalt oxide based catalyst. The modified catalyst includes cobalt oxide; and lanthanum, which is dispersed within the cobalt oxide. The amount of lanthanum being dispersed within the cobalt oxide is about 5-20% by weight of the modified cobalt oxide based catalyst. In one example, the amount of lanthanum being dispersed within the cobalt oxide is about 10% by weight of the modified cobalt oxide based catalyst.

In a second aspect of this disclosure, a method of fabricating the afore-mentioned improved cobalt oxide based catalyst is provided. The method includes steps of: forming a dispersion by dissolving cobalt oxide in water; adding lanthanum ions to the dispersion so that the lanthanum ions are dispersed within the cobalt oxide and thereby forming a cobalt oxide based catalyst; drying the cobalt oxide based catalyst; and reducing the cobalt oxide based catalyst to form the modified cobalt oxide based catalyst. According to one example of the present disclosure, the amount of lanthanum being dispersed within the cobalt oxide is about 10% by weight of the modified cobalt oxide based catalyst. In one example, the cobalt oxide based catalyst is dried at a temperature of about 110° C. for about 24 hours. In another example, the modified catalyst is reduced by hydrogen at a temperature of about 200° C. for about 3 hours. In one specific example, the modified catalyst is reduced by a mixture of hydrogen and nitrogen in a ratio of about 9:1.

According to one embodiment of the present disclosure, the method may further comprise a step of calcining the cobalt oxide based catalyst at a temperature of about 300° C. to 700° C. for at least 3 hours before reducing the cobalt oxide based catalyst to form the modified cobalt oxide based catalyst.

According to a third aspect of this disclosure, a method of catalytically producing hydrogen is provided. The method includes steps of: flowing an ethanol solution through a modified cobalt oxide based catalyst at a temperature of about 350-450° C. such that the modified cobalt oxide based catalyst may catalyze the ethanol solution to produce a hydrogen containing gas, wherein the modified cobalt oxide based catalyst includes cobalt oxide; and lanthanum, which is dispersed within the cobalt oxide; and the amount of lanthanum being dispersed within the cobalt oxide is about 5-20% by weight of the modified cobalt oxide based catalyst. In one example, the amount of lanthanum being dispersed within the cobalt oxide is about 10% by weight of the modified catalyst. The modified cobalt oxide based catalyst may be used for at least 60 hours without losing its catalytic activity. In one example, the ethanol solution has a concentration of about 20% by volume. In one example, the ethanol solution is catalyzed by the modified cobalt oxide based catalyst to produce hydrogen at a temperature of about 425° C. In another example, the method has conversion efficiency for about 100%, that is, nearly all ethanol solution that flows through the modified cobalt oxide based catalyst of this disclosure would be converted into hydrogen gas at the described condition.

These and other features, aspects, and advantages of the present disclosure will become better understood with reference to the following description and appended claims.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

In the drawings,

FIG. 1 is a schematic diagram illustrating an ethanol-hydrogen conversion apparatus according to one embodiment of this disclosure;

FIG. 2 is a diagram illustrating the respective relationship of the yield of hydrogen production (Y_{H2}) and the ratio of C_{EtOH}/F_{Products} with the reaction temperature in the ethanol-hydrogen conversion process catalyzed by the modified lanthanum cobalt based catalyst (10La/CoOₓ(H)) according to one embodiment of this disclosure;

FIG. 3 is a diagram illustrating the respective relationship of the yield of hydrogen production (Y_{H2}) and the ratio of C_{EtOH}/F_{Products} with the reaction temperature in the ethanol-hydrogen conversion process catalyzed by the modified lanthanum cobalt based catalyst (5La/CoOₓ(H)) according to one embodiment of this disclosure;

FIG. 4 is a diagram illustrating the respective relationship of the yield of hydrogen production (Y_{H2}) and the ratio of C_{EtOH}/F_{Products} with the reaction temperature in the ethanol-hydrogen conversion process catalyzed by the modified lanthanum cobalt based catalyst (20La/CoOₓ(H)) according to one embodiment of this disclosure;

FIG. 5 is a diagram illustrating the respective relationship of the yield of hydrogen production (Y_{H2}) and the ratio of C_{EtOH}/F_{Products} with the reaction temperature in the ethanol-hydrogen conversion process catalyzed by the modified cobalt based catalyst (CoOₓ(H)) according to one embodiment of this disclosure;

FIG. 6 is a diagram illustrating the respective relationship of the yield of hydrogen production (Y_{H2}) and the ratio of C_{EtOH}/F_{Products} with the reaction temperature in the ethanol-hydrogen conversion process catalyzed by the modified lanthanum cobalt based catalyst having been calcified at 300° C. (10La/CoOₓ(C300-H)) according to one embodiment of this disclosure;

FIG. 7 is a diagram illustrating the respective relationship of the yield of hydrogen production (Y_{H2}) and the ratio of C_{EtOH}/F_{Products} with the reaction temperature in the ethanol-hydrogen conversion process catalyzed by the modified lanthanum cobalt based catalyst having been calcified at 500° C. (10La/CoOₓ(C500-H)) according to one embodiment of this disclosure; and

FIG. 8 is a diagram illustrating the respective relationship of the yield of hydrogen production (Y_{H2}) and the ratio of C_{EtOH}/F_{Products} with the reaction temperature in the ethanol-hydrogen conversion process catalyzed by the modified lanthanum cobalt based catalyst having been calcified at 700° C. (10La/CoOₓ(C700-H)) according to one embodiment of this disclosure.

### DETAIL DESCRIPTION OF ILLUSTRATED EMBODIMENTS

Reference will now be made in detail to the preferred embodiments of the disclosure, examples of which are illustrated in the accompanying drawings. Wherever possible, the same reference numbers are used in the drawings and the description to refer to the same or like parts.

Embodiments of the present disclosure are directed to the issue of reducing the amount of carbon being produced and accumulated in a hydrogen production system using the known cobalt oxide based catalyst. Inventors of the present disclosure improve the known cobalt oxide based catalyst by adding lanthanum ions therein to absorb carbon dioxide by-product produced during the SRE process, therefore, the amount of carbon being accumulated on the surface of the catalyst may be effectively reduced, and thereby prolongs the life-time and stability of the catalyst.

Lanthanum is a silver white metal with an atomic number of 57, and is a member of the lanthanoid series. Lanthanum element is usually found in rare earth ore such as monazite or bastnasite, and is often bound with cesium and other rare earth elements. It is known that lanthanum element has good malleability and may be easily bound with ambient oxygen. Lanthanum may be used in various applications including catalyst, glass additives, polishing machine, or the flaming elements of a torch. Further, lanthanum oxide may react with carbon dioxide to form a stable compound, La₂O₂CO₃, therefore the accumulated carbon in a hydrogen production system may be effectively reduced and the life-time of the cobalt oxide based catalyst is prolonged.

According to one example of the present disclosure, a modified cobalt oxide based catalyst is provided. The modified catalyst includes cobalt oxide; and lanthanum, which is dispersed within the cobalt oxide. The amount of lanthanum being dispersed within the cobalt oxide is about 5-20% by weight of the modified catalyst. In one example, the amount of lanthanum being dispersed within the cobalt oxide is about 10% by weight of the modified catalyst. A method of preparing the afore-mentioned modified cobalt oxide based catalyst, and the use of the modified cobalt oxide based catalyst for the catalytic production of hydrogen from ethanol will be described in detail in paragraphs below

### Preparation Method of the Modified Cobalt Oxide Based Catalyst

In the preparation of the modified cobalt oxide based catalyst, suitable amount of cobalt nitrate [Co(NO)₂.6H₂O] are dissolved in distilled water to produce a cobalt nitrate solution having a concentration of about 0.6 M. The solution is mixed thoroughly for about an hour using a magnetic stirrer under suitable magnetic force to ensure complete dissolution of the added cobalt nitrate. Then, sodium oxide solution (3.2M) is flowed through the cobalt nitrate solution in a flow rate of about 10 ml/min, and the mixture is continuously stirred to for another 3 hours to form cobalt hydroxide (Co(OH)₂), which precipitates at the bottom of the solution A reducing agent, such as 30% hydrogen peroxide, is then added into the solution containing cobalt hydroxide precipitate, and the mixture is continuously stirred for another 3 hours. The mixture is then filtered, and the precipitate is washed several times with water until the washings or the water that passes through the precipitate has a pH value of about 7.0. The product is then dried in an oven at a temperature of about 110° C. for 24 hours to result a dark brown powder, which is termed “high valence cobalt oxide (CoOₓ).”

Various amounts of lanthanum nitrate (La(NO₃)₃.6H₂O) are dissolved in water to form lanthanum nitrate solution having various concentrations, and the volume of water required to produce the desired lanthanum nitrate solution depends on whether completely dissolution of lanthanum nitrate is achieved or not. Further, the afore-prepared high valence cobalt oxide (CoOₓ) (9 g) is added into water (150 ml) to form a cobalt oxide dispersion. Next, the lanthanum nitrate solution is added drop-wisely into the cobalt oxide dispersion and the mixture is continuously stirred for 24 hours to ensure all lanthanum ions are dispersed within the cobalt oxide.

The resulted dispersion is then dried in an oven at a temperature of about 110° C. for 24 hours to remove moisture and thereby forms a modified cobalt oxide based catalyst. An optional calcination step may be performed at this stage. Specifically, the modified cobalt oxide based catalyst is optionally calcined at a temperature between about 300° C. to 700° C. for 3 hours.

The resulted modified catalyst is then placed in suitable containers and stored in a desiccated environment until used. Upon testing, the catalyst is subjected to tableting, crushing, screening (using mesh size about 60-80), and reducing at 200° C. In one example, the reducing agent is hydrogen. In another example, a mixture of hydrogen and nitrogen in a ratio of about 9:1 (H₂:N₂=9:1) is used for such purpose.

Process for Converting Ethanol into Hydrogen

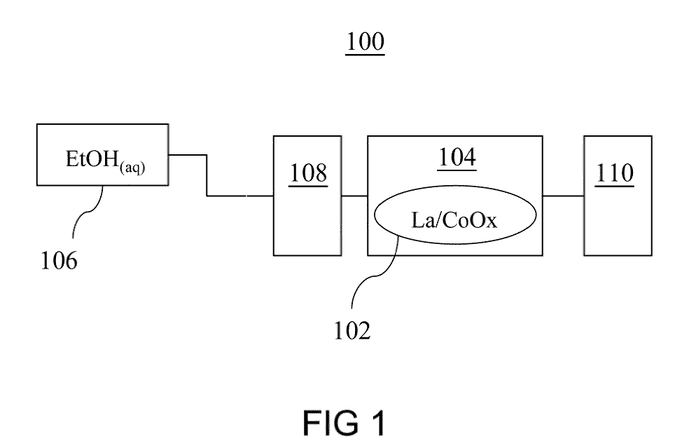

Reference is now made to FIG. 1, which is a schematic diagram illustrating a conversion apparatus 100 used for catalytically converting ethanol into hydrogen in accordance with one embodiment of this disclosure. First, the modified cobalt oxide based catalyst 102 (0.1 g) prepared as described above is placed in a continuous flow fixed-bed reactor 104, which is completely wrapped by a heating band (not shown). Ethanol solution (20% by volume), which is housed in a container 106, is injected into a mixing cell 108 via a pump in a flow rate of 15.4 ml/min along with a carrier gas (e.g., Ar), which has a flow rate of about 23 ml/min, and the mixture is heated and vaporized in the mixing cell 108. The resulted gas mixture (i.e. ethanol vapor and carrier gas) then enters the fixed-bed reactor 104 and reacted with the catalyst there within, and the total flow rate of the gas mixture is maintained at a rate of about 38.4 ml/min.

The temperature of the fixed-bed reactor 104 is set at a range from about 350° C. to about 475° C., and the heating may be performed in various stages. The ethanol vapor is continuously fed into the fixed-bed reactor 104 at a pre-determined temperature, and reacted there within with the catalyst for 2 hours. The resulted product then enters an analyzer for product isolation and identification. The temperature of the fixed-bed reactor 104 may then be elevated to a temperature suitable for next reaction.

### Product Analysis

The product may be isolated and analyzed by gas chromatography (GC). In one example, two GC columns, Porapak. Q and MS-5A, are used for product isolation and identification. The Porapak Q column may be used to isolate CO₂, C₂H₂, H₂O, CH₃CHO and C₂H₅OH, whereas MS-5A column may be used to isolate H₂, O₂, CH₄ and CO. The isolated compounds are then quantified by thermal conductivity detector (TCD) and the conversion efficiency of ethanol (C_{EtOH}), hydrogen yield (Y_{H2}) and distribution of CO₂ (F_{CO2}) are respectively calculated in accordance with the following equations:

$${C}_{EtOH} = \frac{{n}_{EtOH - in} - {n}_{EtOH - out}}{{n}_{EtOH - in}} \times 100 \%$$

$${Y}_{H 2} = \frac{{n}_{{H}_{2} - out}}{[ ( \frac{1}{2} ) ( \begin{matrix}{n}_{{CH}_{4} - out} + {n}_{CO - out} + \\ {n}_{{CO}_{2} - out}\end{matrix} ) ] + {n}_{{CH}_{3} {CHO}_{out}} + \frac{3}{2} {n}_{{C}_{3} {H}_{6} O - out}}$$

$${F}_{CO 2} = \frac{{n}_{CO 2 - out}}{{n}_{H 2 - out} + {n}_{CH 4 - out} + {n}_{CO - out} + {n}_{CO 2 - out} + {n}_{C 3 H 6 O - out}} \times 100 \%$$

wherein n_{EtOH-in} and n_{EtOH-out} respectively represents moles of ethanol before and after conversion; n_{H2-out}, n_{CH4-out}, n_{CO-out}, n_{CO2-out}, n_{CH3CHO-out} and n_{CH3H6O-out} respectively represents moles of ethanol after conversion.

### EXAMPLE A1

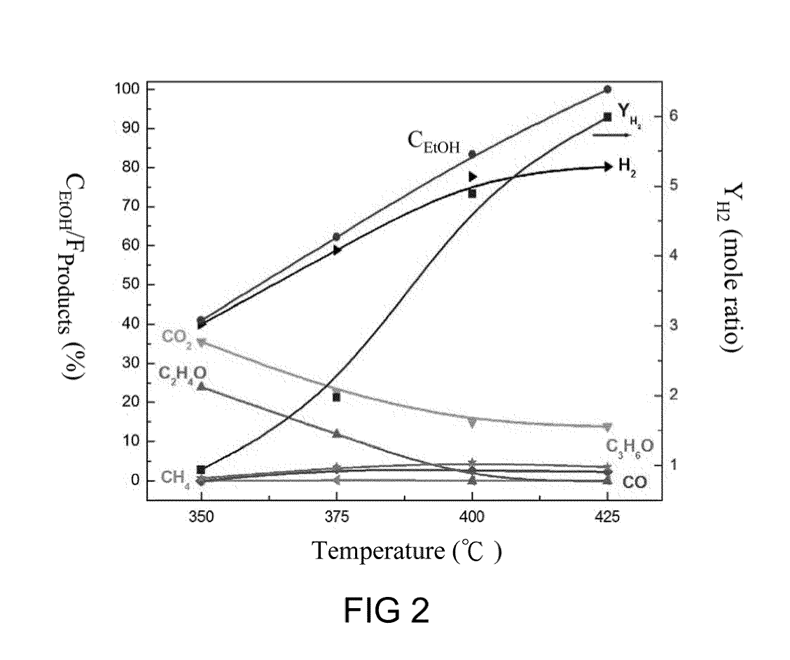

3.12 g of lanthanum nitrate was dissolved in water (50 ml) to form a 10% (wt %) lanthanum nitrate solution, and was subsequently used for the preparation of the modified cobalt oxide based catalyst in accordance with the process described above, and the prepared modified catalyst was further reduced by hydrogen at a temperature of about 200° C. for 3 hours, and the modified catalyst after hydrogen reduction was named 10La/CoOₓ(H). This modified catalyst was then used in ethanol-hydrogen conversion process, and the products were analyzed by GC chromatography in accordance with steps described above, in which the gas hour space velocity (GHSV) in the GC apparatus was maintained at about 22,000/h, and the entire catalytic conversion process run for approximately 60 hours at various temperatures including 350° C., 375° C., 400° C. and 425° C., and the results were as indicated in Table 1 or as illustrated in FIG. 2. It is to be noted that the reaction time indicated at each reaction temperature represents the total accumulated time.

TABLE 1

| | Reaction | Reaction | | | | |
|---|---|---|---|---|---|---|
| | Temperature | Time | C_{EtOH} | | F_{CO2} | n_{H2}/n_{EtOH} |
| catalyst | (° C.) | (hr) | (%) | Y_{H2} (%) | (%) | (mol ratio) |
| 10La/ | 350 | 6 | 40.9 | 39.9 | 35.5 | 0.94 |
| CoOₓ(H) | 375 | 10 | 62.2 | 58.8 | 22.5 | 1.97 |
| | 400 | 18 | 83.3 | 77.6 | 14.9 | 4.89 |
| | 425 | 60 | 100 | 80.2 | 13.7 | 5.99 |

### EXAMPLE A2

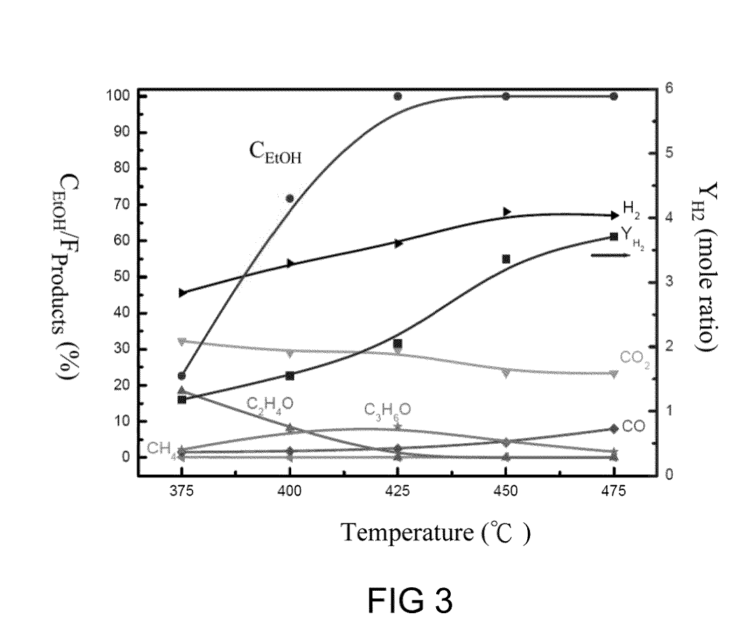

1.56 g of lanthanum nitrate was dissolved in water (50 ml) to form a 5% (w, %) lanthanum nitrate solution, and was subsequently used for the preparation of the modified cobalt oxide based catalyst in accordance with the process described above, and the prepared modified catalyst was further reduced by hydrogen at a temperature of about 200° C. for 3 hours, and the modified catalyst after hydrogen reduction was named 5La/CoOₓ(H). This modified catalyst was then used in ethanol-hydrogen conversion process, and the products were analyzed by GC chromatography in accordance with steps described above. The gas hour space velocity (GHSV) in the GC apparatus was maintained at about 22,000/h, and the entire catalytic conversion process run for approximately 60 hours at various temperatures, and the results were as indicated in Table 2 or as illustrated in FIG. 3. It is to be noted that the reaction time indicated at each reaction temperature represents the total accumulated time.

TABLE 2

| | Reaction | Reaction | | | | |
|---|---|---|---|---|---|---|
| | Temperature | Time | C_{EtOH} | | F_{CO2} | n_{H2}/n_{EtOH} |
| catalyst | (° C.) | (hr) | (%) | Y_{H2} (%) | (%) | (mol ratio) |
| 5La/ | 375 | 6 | 22.6 | 45.5 | 32.2 | 1.1 |
| CoOₓ(H) | 400 | 10 | 71.7 | 53.7 | 28.9 | 1.5 |
| | 425 | 20 | 100 | 59.2 | 29.7 | 2 |
| | 450 | 30 | 100 | 68 | 23.4 | 3.3 |
| | 475 | 60 | 100 | 67 | 23.3 | 3.7 |

### EXAMPLE A3

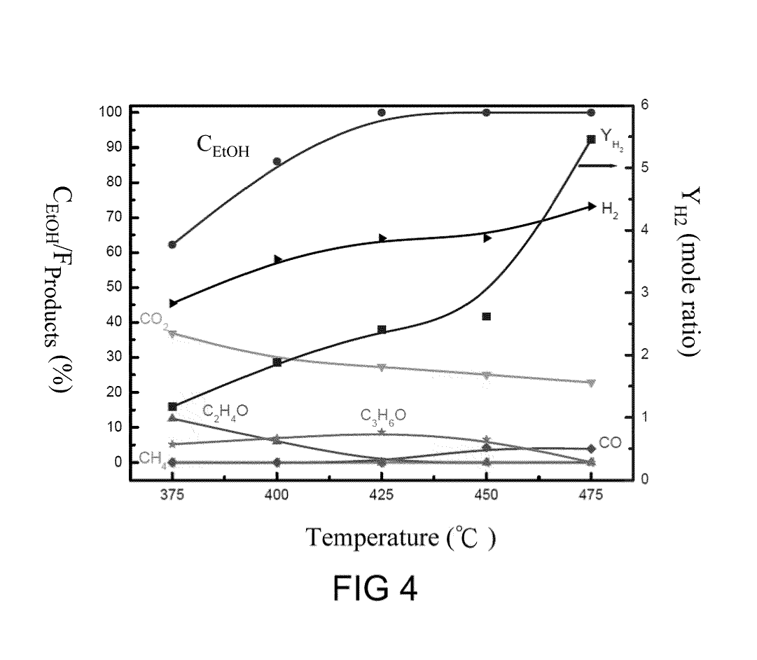

6.24 g of lanthanum nitrate was dissolved in water (50 ml) to form a 20% (wt %) lanthanum nitrate solution, and was subsequently used for the preparation of the modified cobalt oxide based catalyst in accordance with the process described above, and the prepared modified catalyst was further to reduced by hydrogen at a temperature of about 200° C. for 3 hours, and the modified catalyst after hydrogen reduction was named 20La/CoOₓ(H). This modified catalyst was then used in ethanol-hydrogen conversion process, and the products were analyzed by GC chromatography in accordance with steps described above. The gas hour space velocity (GHSV) in the GC apparatus is was maintained at about 22,000/h, and the entire catalytic conversion process run for approximately 60 hours at various temperatures, and the results were as indicated in Table 3 or as illustrated in FIG. 4. It is to be noted that the reaction time indicated at each reaction temperature represents the total accumulated time.

TABLE 3

| | Reaction | Reaction | | | | |
|---|---|---|---|---|---|---|
| | Temperature | Time | C_{EtOH} | | F_{CO2} | n_{H2}/n_{EtOH} |
| catalyst | (° C.) | (hr) | (%) | Y_{H2} (%) | (%) | (mol ratio) |
| 20La/ | 375 | 6 | 62.2 | 45.4 | 36.8 | 1.1 |
| CoOₓ(H) | 400 | 10 | 86 | 58 | 29 | 1.8 |
| | 425 | 20 | 100 | 64 | 27.3 | 2.4 |
| | 450 | 30 | 100 | 64.1 | 25 | 2.6 |
| | 475 | 60 | 100 | 73.2 | 22.8 | 5.4 |

### COMPARATIVE EXAMPLE A4

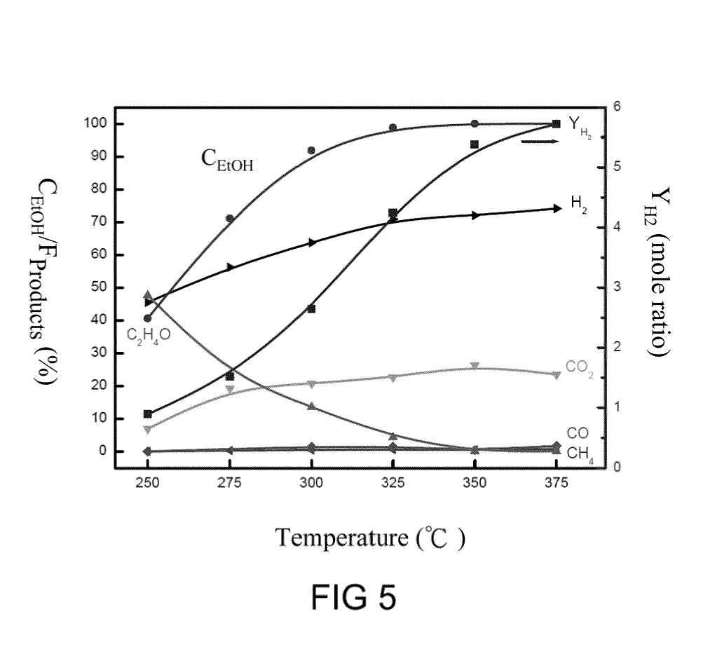

2 g of the high valence cobalt oxide catalyst (CoOₓ) was reduced by hydrogen at a temperature of about 200° C. for 3 hours, and the modified catalyst after hydrogen reduction was named CoOₓ(H). This modified catalyst was then used in ethanol-hydrogen conversion process, and the products were to analyzed by GC chromatography in accordance with steps described above. The gas hour space velocity (GHSV) in the GC apparatus was maintained at about 22,000/h, and the entire catalytic conversion process run for approximately 48 hours at various temperatures, and the results were as indicated in Table 4 or as illustrated in FIG. 5. It is to be noted that the reaction is time indicated at each reaction temperature represents the total accumulated time.

It was noted that coke produced during the conversion reaction would accumulated on the surface of the modified catalyst.

TABLE 4

| | Reaction | Reaction | | | | |
|---|---|---|---|---|---|---|
| | Temperature | Time | C_{EtOH} | | F_{CO2} | n_{H2}/n_{EtOH} |
| catalyst | (° C.) | (hr) | (%) | Y_{H2} (%) | (%) | (mol ratio) |
| CoOₓ(H) | 250 | 8 | 40.6 | 45.5 | 6.9 | 0.89 |
| | 275 | 14 | 71.1 | 56.2 | 19.2 | 1.52 |
| | 300 | 18 | 91.8 | 63.7 | 20.7 | 2.64 |
| | 325 | 24 | 98.8 | 70.9 | 22.6 | 4.25 |
| | 350 | 36 | 100 | 72.0 | 26.3 | 5.38 |
| | 375 | 48 | 100 | 74.1 | 23.4 | 5.72 |

In view of the afore-mentioned described examples and comparative example, the modified cobalt oxide based catalyst comprising lanthanum of the present disclosure may effectively reduce the amount of carbon being accumulated on the surface of the catalyst and thereby may prolong the life time of the catalyst. The life time of the modified catalyst has been prolonged from 48 hours (see comparative example A4) to at least 60 hours (see examples A1 to A3) without any coke being accumulated on the surface of the modified catalyst. However, the lanthanum modified cobalt oxide based catalyst of the present disclosure would require a higher temperature for a complete conversion of ethanol into hydrogen when compared with that of the unmodified cobalt based catalyst. The yield of hydrogen produced by any of the lanthanum modified catalysts of examples A1, A2 or A3 increases with an increase of the reaction temperature, whereas the yield of CO₂ production decreases as the reaction temperature increases. All 3 lanthanum modified cobalt oxide based catalysts have 100% conversion efficiency at 425° C., with the lanthanum modified catalyst (10La/CoOₓ(H)) of example A1 being the one having the maximum hydrogen to ethanol (n_{H2}/n_{EtOH}) mole ratio, which is about 5.99, at the reaction temperature of 425° C.; at the same time, the reduction of CO₂ also reaches its maximum value at 425° C.

In view of the above, the following examples were performed using the modified catalyst of example A1 (i.e., 10La/CoOₓ(H)) except the modified catalyst of example A1 was further subjected to a calcination treatment at various temperatures before being subjected to hydrogen reduction for subsequent use in the ethanol-hydrogen conversion process, and the effect of calcification on the conversion process was subsequently evaluated.

### EXAMPLE B1

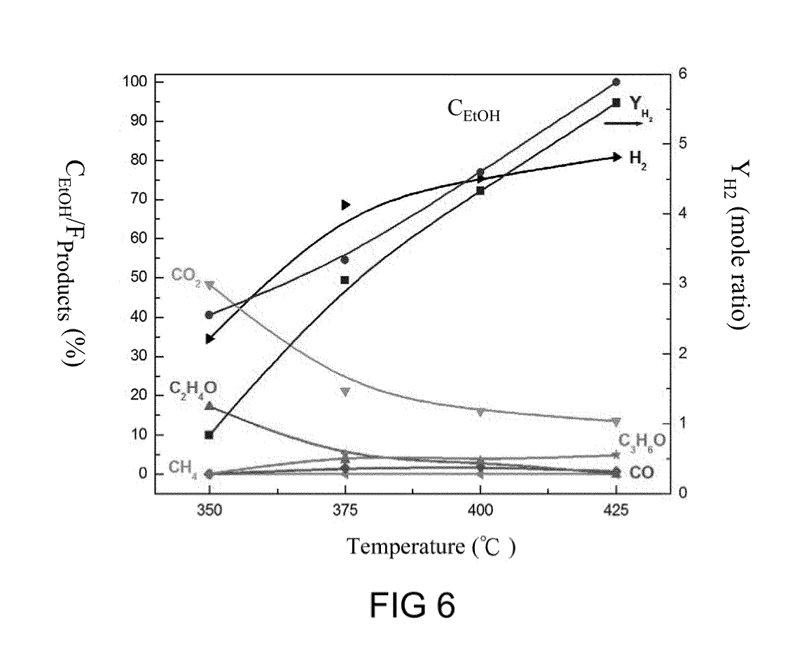

3.12 g of lanthanum nitrate was dissolved in water (50 ml) to form a 10% (wt %) lanthanum nitrate solution, and was subsequently used for the preparation of the modified cobalt oxide based catalyst in accordance with the process described above. The modified catalyst was then calcified at a temperature of 300° C. for 3 hours, followed by hydrogen reduction at a temperature of about 200° C. for 3 hours, and the modified catalyst after hydrogen reduction was named 10La/CoOₓ(C300-H). This modified catalyst was then used in ethanol-hydrogen conversion process, and the products were analyzed by GC chromatography in accordance with steps described above. The gas hour space velocity (GHSV) in the GC apparatus was maintained at about 22,000/h, and the entire catalytic conversion process run for approximately 60 hours at various temperatures, and the results were as indicated in Table 5 or as illustrated in FIG. 6. It is noted that the reaction time indicated at each reaction temperature represents the total accumulated time.

TABLE 5

| | Reaction | Reaction | | | | |
|---|---|---|---|---|---|---|
| | Temperature | Time | C_{EtOH} | Y_{H2} | F_{CO2} | n_{H2}/n_{EtOH} |
| catalyst | (° C.) | (hr) | (%) | (%) | (%) | (mol ratio) |
| 10La/ | 350 | 6 | 40.5 | 34.5 | 48.2 | 0.84 |
| CoOₓ(C300- | 375 | 10 | 54.5 | 68.6 | 21.1 | 3.05 |
| H) | 400 | 23 | 76.9 | 75.3 | 15.9 | 4.33 |
| | 425 | 60 | 100 | 80.8 | 13.4 | 5.59 |

### EXAMPLE B2

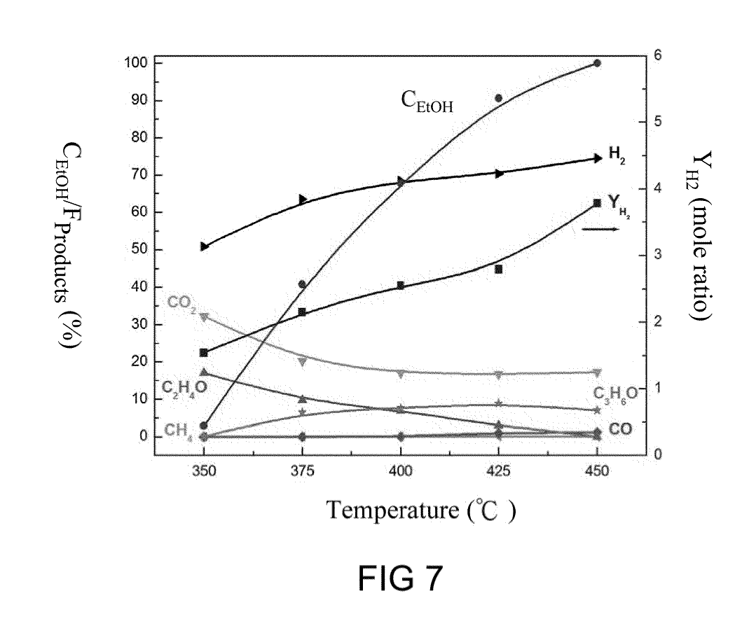

3.12 g of lanthanum nitrate was dissolved in water (50 ml) to form a 10% (wt %) lanthanum nitrate solution, and was subsequently used for the preparation of the modified cobalt oxide based catalyst in accordance with the process described above. The modified catalyst was then calcified at a temperature of 500° C. for 3 hours, followed by hydrogen reduction at a temperature of about 200° C. for 3 hours, and the modified catalyst after hydrogen reduction was named 10La/CoOₓ(C300-H). This modified catalyst was then used in ethanol-hydrogen conversion process, and the products were analyzed by GC chromatography in accordance with steps described above. The gas hour space velocity (GHSV) in the GC apparatus was maintained at about 22,000/h, and the entire catalytic conversion process run for approximately 60 hours at various temperatures, and the results were as indicated in Table 6 or as illustrated in FIG. 7. It is noted that the reaction time indicated at each reaction temperature represents the total accumulated time.

TABLE 6

| | | | | | | n_{H2}/ |
|---|---|---|---|---|---|---|
| | Reaction | Reaction | | | | n_{EtOH} |
| | Temperature | Time | C_{EtOH} | Y_{H2} | F_{CO2} | (mol |
| Catalyst | (° C.) | (hr) | (%) | (%) | (%) | ratio) |
| 10La/ | 350 | 4 | 2.91 | 50.8 | 32.1 | 1.54 |
| CoOₓ(C500-H) | 375 | 12 | 40.8 | 63.5 | 20.2 | 2.15 |
| | 400 | 20 | 67.7 | 68.4 | 16.9 | 2.55 |
| | 425 | 36 | 90.5 | 70.3 | 16.6 | 2.79 |
| | 450 | 60 | 100 | 74.5 | 17.2 | 3.78 |

### EXAMPLE B3

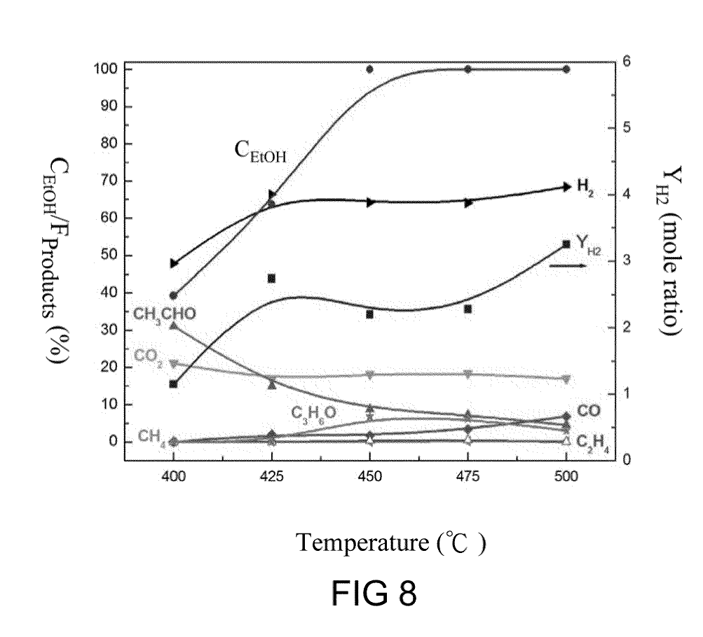

3.12 g of lanthanum nitrate was dissolved in water (50 ml) to form a 10% (wt %) lanthanum nitrate solution, and was subsequently used for the preparation of the modified cobalt oxide based catalyst in accordance with the process described above. The modified catalyst was then calcified at a temperature of 700° C. for 3 hours, followed by hydrogen reduction at a temperature of about 200° C. for 3 hours, and the modified catalyst after hydrogen reduction was named 10La/CoOₓ(C300-H). This modified catalyst was then used in ethanol-hydrogen conversion process, and the products were analyzed by GC chromatography in accordance with steps described above. The gas hour space velocity (GHSV) in the GC apparatus was maintained at about 22,000/h, and the entire catalytic conversion process run for approximately 80 hours at various temperatures, and the results were as indicated in Table 7 or as illustrated in FIG. 8. It is noted that the reaction time indicated at each reaction temperature represents the total accumulated time.

TABLE 7

| | | | | | | n_{H2}/ |
|---|---|---|---|---|---|---|
| | Reaction | Reaction | | | | n_{EtOH} |
| | Temperature | Time | C_{EtOH} | | F_{CO2} | (mol |
| Catalyst | (° C.) | (hr) | (%) | Y_{H2} (%) | (%) | ratio) |
| 10La/ | 400 | 12 | 39.3 | 47.8 | 21.1 | 1.15 |
| CoOₓ(C700-H) | 425 | 16 | 63.7 | 66.4 | 16.6 | 2.74 |
| | 450 | 24 | 100 | 64.2 | 18.1 | 2.2 |
| | 475 | 48 | 100 | 64 | 18.4 | 2.28 |
| | 500 | 60 | 100 | 68.4 | 16.9 | 3.25 |

The foregoing description of various embodiments of the disclosure has been presented for purpose of illustration and description. It is not intended to be exhaustive or to limit the disclosure to the precise embodiments disclosed. Numerous modifications or variations are possible in light of the above teachings. The embodiments discussed were chosen and described to provide the best illustration of the principles of the disclosure and its practical application to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A modified cobalt oxide based catalyst, comprising:
cobalt oxide; and
lanthanum, which is dispersed within the cobalt oxide, wherein the amount of lanthanum being dispersed within the cobalt oxide is about 5-20% by weight of the modified cobalt oxide based catalyst.

2. The modified cobalt oxide based catalyst of claim 1, wherein the amount of lanthanum is about 10% by weight of the modified cobalt oxide based catalyst.

3. A method of fabricating the modified cobalt oxide based catalyst of claim 1, comprising:
forming a dispersion by dissolving cobalt oxide in water;
adding lanthanum ions to the dispersion so that the lanthanum ions are dispersed within the cobalt oxide and thereby forming a cobalt oxide based catalyst;
drying the cobalt oxide based catalyst; and
reducing the cobalt oxide based catalyst to form the modified cobalt oxide based catalyst.

4. The method of claim 3, wherein the amount of the lanthanum being dispersed within the cobalt oxide is about 10% by weight of the modified cobalt oxide based catalyst.

5. The method of claim 3, wherein the step of drying the cobalt oxide based catalyst is performed under a temperature of about 110° C. for about 24 hours.

6. The method of claim 3, further comprising the step of calcifying the cobalt oxide based catalyst at a temperature of about 300° C. to 700° C. for about 3 hours before reducing the cobalt oxide based catalyst to form the modified cobalt oxide based catalyst.

7. The method of claim 3, wherein the step of reducing the cobalt oxide based catalyst is performed at a temperature of about 200° C. for about 3 hours.

8. The method of claim 3, wherein the step of reducing the cobalt oxide based catalyst comprising using hydrogen as a reducing agent.

9. The method of claim 8 wherein the step of reducing the catalyst comprising using a mixture of hydrogen and nitrogen in a ratio of about 9:1 as the reducing agent.

10. A method of catalytically producing hydrogen, comprising:
flowing an ethanol solution through the modified cobalt oxide based catalyst of claim 1 at a temperature of about 350-450′C such that the modified cobalt oxide based catalyst may catalyze the ethanol solution to produce a hydrogen containing gas.

11. The method of claim 10, wherein the modified cobalt oxide based catalyst is capable of catalyzing the ethanol solution to produce the hydrogen containing gas for at least 60 hours.

12. The method of claim 10, wherein the amount of lanthanum being dispersed within the cobalt oxide is about 10% by weight of the modified cobalt oxide based catalyst.

13. The method of claim 10, wherein the ethanol solution has a concentration of about 20% by volume.

14. The method of claim 10, wherein the temperature is about 425° C.

15. The method of claim 10, wherein the method has a conversion efficiency of about 100% for converting ethanol into hydrogen.
